(19) United States
(12) Patent Application Publication
(10) Pub. No.: US 2016/0236506 A1
(43) Pub. Date: Aug. 18, 2016

(54) Writing Instrument Having A Replaceable Sleeve

(71) Applicants: Kristin Michelle Davis, Lakeland, FL (US); Steven Shepherd Davis, Lakeland, FL (US)

(72) Inventors: Kristin Michelle Davis, Lakeland, FL (US); Steven Shepherd Davis, Lakeland, FL (US)

(21) Appl. No.: 14/707,815

(22) Filed: May 8, 2015

Related U.S. Application Data
(60) Provisional application No. 62/116,378, filed on Feb. 14, 2015.

(51) Int. Cl. B43K 23/08

(52) U.S. Cl. CPC B43K 23/08

(57) ABSTRACT

A replaceable sleeve configured to cover a writing instrument. The writing instrument has a primary end located opposite a secondary end. The secondary end of the writing instrument has an outer ridge having a step. The sleeve has an end having a secondary opening located opposite another end having a primary opening. The primary opening of the sleeve receives the primary end of the writing instrument. The primary end of the writing instrument is configured to protrude from the secondary opening of the sleeve. An inner ridge is connected to an inner wall surface of the sleeve. When the sleeve covers a substantial amount of the writing instrument, the secondary end of the replaceable sleeve conforms around the outer ridge of the writing instrument. The outer ridge has a step that interlocks with the inner ridge of the sleeve, thereby, retaining the sleeve on the writing instrument.

### CROSS REFERENCE TO RELATED APPLICATIONS

This application is a non-provisional application, entitled, “Writing Instrument Having A Replaceable Sleeve,” which claims priority to U.S. Provisional Patent Application No. 62/116/378 filed Feb. 14, 2015, entitled, “Writing Implement Sheath and Housing for Dispensing Sheaths.”

### BACKGROUND OF THE INVENTION

1. Field of the Invention

The present invention relates, generally, to a replaceable sleeve for a writing instrument. More particularly, it relates to a replaceable sleeve having an inner ridge configured to conform around an outer ridge of a writing instrument.

2. Background Art

Many medical facilities such as a hospital, an assisted living facility, or a doctor's office attempt to control the spread of infectious diseases by mandating procedures for sanitizing writing instruments such as a pen, a pencil, a digital pen, or a stylus being exposed directly to a patient or being exposed to bodily fluids or aerosols expelled from a patient with an alcohol-based sanitizing agent. The problem with a user being required to wipe the surface of a writing instrument with alcohol-based sanitizing agent is that the user may be exposed to harsh chemicals that can dry or crack a user's skin. Thus, there is a need to prevent a writing instrument from being contaminated with these infectious diseases.

Currently, the process of disinfecting writing instruments requires a user to apply alcohol-based sanitizing agent to a writing instrument. It can be messy when a user is smearing handfuls of sanitizer on a writing instrument. It can also be unsanitary for a user to come into contact with the contaminants on the writing implement when a user is applying sanitizing agent to the surface of a contaminated writing instrument. It is more desirable and safer for a user to decontaminate a writing instrument without requiring a user to have to physically contact a contaminated surface of the writing instrument. Thus, there is a need for a replaceable sleeve configured to be removable from a writing instrument without requiring a user to contact the contaminated sleeve.

Additionally, the use of alcohol-based sanitizing agent may not be effective in disinfecting all portions of a writing instrument such as the rubber grip, a ridge, a recess, or the underside of the clip portion of a pen cap, which can be prone to heavy concentrations of contaminants. It is more desirable for a user to have a more effective way to prevent contaminants from spreading to a writing instrument. Thus, there is a need for a replaceable sleeve configured to substantially cover the surface of a writing instrument. The vast majority of commercially available replaceable sanitation barriers in the healthcare industry include items such as latex gloves, paper gowns, headrest covers, exam table paper, and otoscope specula. A writing instrument can be exposed to a variety of contaminants such as viruses and bacteria. A writing instrument can facilitate the spread of these contaminants to many users such as a patient or a healthcare provider when they come into contact with the writing instrument. What is therefore needed is a replaceable sanitation sleeve for a writing instrument that can be replaced in between contact with differing users.

However, in view of the prior art considered as a whole at the time the present invention was made, it was not obvious to those of ordinary skill in the pertinent art how the identified needs could be fulfilled.

### SUMMARY OF THE INVENTION

The long-standing but heretofore unfulfilled need for a replaceable sleeve configured to cover the outer surface of a writing instrument. The writing instrument has a primary end located opposite a secondary end. The secondary end of the writing instrument has an outer ridge having a step. The replaceable sleeve has a tapered end having a secondary opening located opposite a receiving end having a primary opening. The primary opening of the replaceable sleeve is configured to receive the primary end of the writing instrument. The primary end of the writing instrument is configured to protrude from the secondary opening of the replaceable sleeve. An inner ridge is connected to an inner wall surface of the replaceable sleeve. When the replaceable sleeve covers a substantial amount of the writing instrument, the secondary end of the replaceable sleeve conforms around the outer ridge of the writing instrument. The outer ridge has a step configured to interlock with the inner ridge of the replaceable sleeve, thereby, retaining the replaceable sleeve on the writing instrument. A release mechanism is located on an end of the writing instrument for ejecting the replaceable sleeve which also includes improvements that overcome the limitations of prior art writing instruments having a replaceable sleeve, is now met by a new, useful, and non-obvious invention.

In a preferred embodiment, a writing instrument has a primary end located opposite a secondary end. The secondary end of the writing instrument has an outer ridge connected to an outer wall surface of the writing instrument. The outer ridge has a step. The replaceable sleeve has a primary end having a primary opening located opposite a secondary end having a secondary opening. The primary opening of the replaceable sleeve is configured to receive a writing instrument. A portion of the primary end of the writing instrument is configured to protrude from the secondary opening of the replaceable sleeve when the replaceable sleeve covers a substantial amount of the writing instrument. The replaceable sleeve has an inner ridge connected to an inner wall surface of the replaceable sleeve. The step of the outer ridge is configured to interlock with the inner ridge of the replaceable sleeve, thereby, retaining the replaceable sleeve on the writing instrument.

In an alternate embodiment, the secondary end of the replaceable sleeve can be tapered. The primary end of the replaceable sleeve is configured to conform to the outer ridge of the writing instrument. The primary opening of the replaceable sleeve has a diameter greater in size than the secondary opening of the replaceable sleeve. The replaceable sleeve can have a tab connected to a surface of the replaceable sleeve.

In another embodiment, the secondary end of the writing instrument has a release mechanism with a housing having a primary housing end located opposite a secondary housing end. The primary housing end has an opening configured to receive a portion of the writing instrument. The secondary end has a button configured to be depressed by a user.

In yet another embodiment, at least one replaceable sleeve is configured to be retained within a receptacle. The receptacle can have at least one opening, a plate having a primary side located opposite a secondary side, and a resilient member. The resilient member has a primary end connected to an inner wall of the receptacle and a secondary end connected to the primary side of the plate. The at least one replaceable sleeve is located adjacent to the secondary side of the plate. A force of the resilient member is configured to push both the plate and at least one replaceable sleeve toward the at least one opening. The at least one replaceable sleeve is configured to be oriented in an alignment with the at least one opening for removal from the receptacle.

The receptacle can have at least one attaching element connected to a surface of the receptacle. The receptacle can have at least one opening bordering a compartment. A perimeter of the at least one opening has a pliable material. A portion of the compartment of the receptacle is removable.

In an alternate embodiment, a replaceable sleeve has a primary end having a primary opening located opposite a secondary end having a secondary opening. The primary opening of the replaceable sleeve has a diameter greater in size than the secondary opening of the replaceable sleeve. The primary opening of the replaceable sleeve is configured to receive a writing instrument. The writing instrument has an end with a tip located opposite another end. The replaceable sleeve is configured to cover a substantial portion of the writing instrument when a portion of the tip of the writing instrument protrudes from the secondary opening of the replaceable sleeve.

In an alternate embodiment, the writing instrument has a primary end located opposite a secondary end. The secondary end of the writing instrument has an outer ridge connected to an outer wall surface of the writing instrument. The outer ridge has a step. The secondary end of the writing instrument has a release mechanism having a housing. The housing has a primary housing end located opposite a secondary housing end. The primary housing end has an opening configured to receive a portion of the writing instrument. The secondary end has a button configured to be depressed by a user. The replaceable sleeve has a primary end having a primary opening located opposite a secondary end having a secondary opening. The primary opening of the replaceable sleeve is configured to receive a writing instrument. A portion of the primary end of the writing instrument is configured to protrude from the secondary opening of the replaceable sleeve and the button is configured to protrude from the housing when a replaceable sleeve covers a substantial amount of the writing instrument. The replaceable sleeve has an inner ridge connected to an inner wall surface of the replaceable sleeve. The step of the outer ridge is configured to interlock with the inner ridge of the replaceable sleeve, thereby, retaining the replaceable sleeve on the writing instrument.

### BRIEF DESCRIPTION OF THE DRAWINGS

For a fuller understanding of the nature and objects of the invention, reference should be made to the following detailed description, taken in connection with the accompanying drawings, in which:

FIG. 1 is an exploded side view of the novel replaceable sleeve release mechanism configured to connect to the secondary end on the writing instrument and a replaceable sleeve configured to substantially cover the writing instrument;

FIG. 2 is an exploded side view of the novel replaceable sleeve configured to substantially covering a writing instrument;

FIG. 3 is a side cut-away view of the novel replaceable sleeve having an inner ridge interlocking with the step of the writing instrument when the replaceable sleeve is substantially covering the writing instrument;

FIG. 4 is a side perspective view of the novel replaceable sleeve covering a writing instrument, the replaceable sleeve having a removal tab;

FIG. 5 is a side cut away view of the novel dispensing mechanism for a removable sleeve;

FIG. 6 is a perspective view of the dispensing mechanism for a removable sleeve; and,

FIG. 7 is a perspective view of the dispensing mechanism for a removable sleeve having an attaching element configured to connect to a substantially flat surface.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

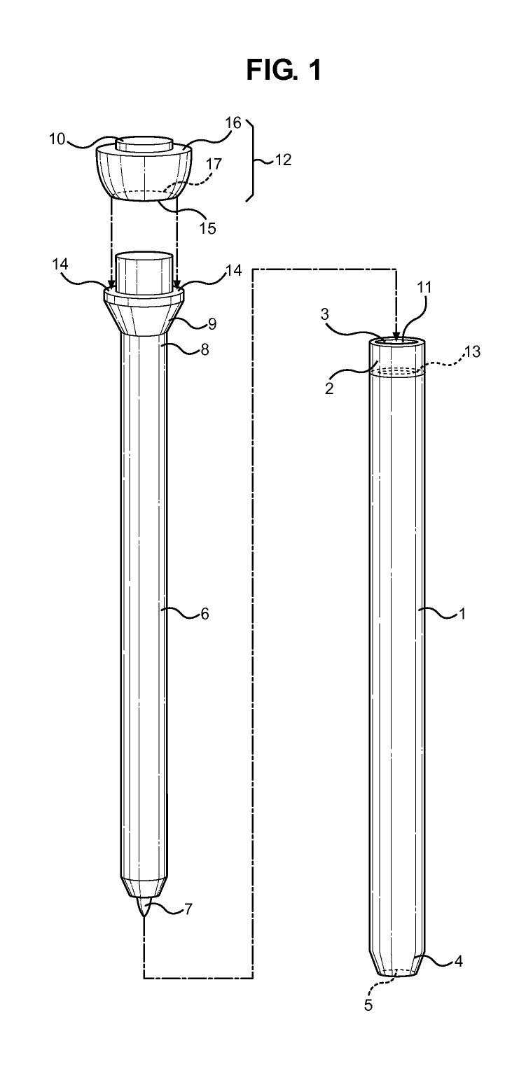

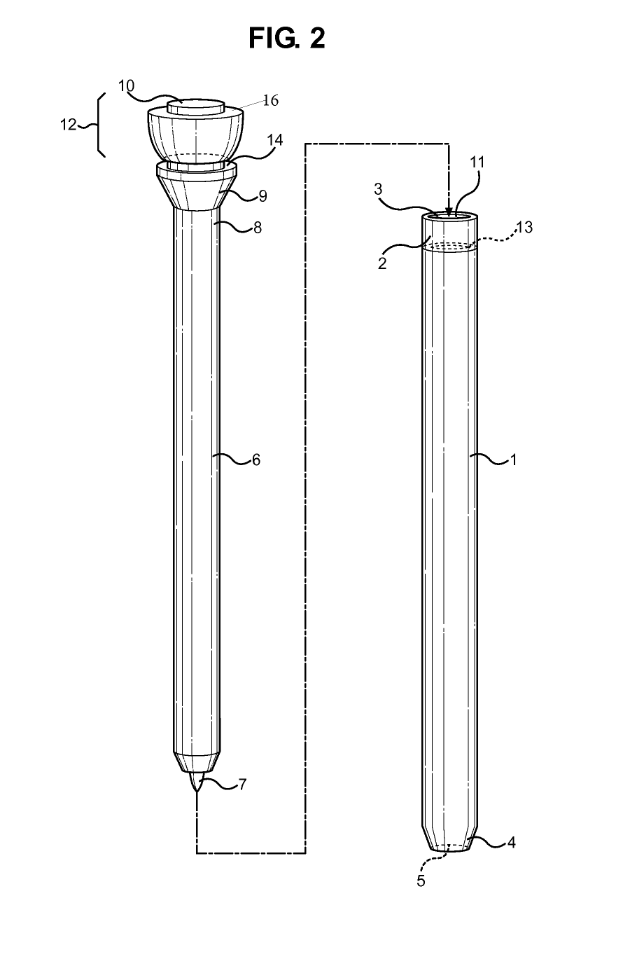

In a preferred embodiment, FIGS. 1-3 and 5 illustrate replaceable sleeve 1 having receiving end 2 having primary opening 3 located opposite tapered end 4 having secondary opening 5. Writing instrument 6 has primary end 7 located opposite secondary end 8. Outer ridge 9 protrudes from an outer perimeter surface of secondary end 8 of writing instrument 6. Outer ridge 9 has step 14 configured to interlock with inner ridge 13 of replaceable sleeve 1 when replaceable sleeve 1 covers a substantial amount of writing instrument 6. A portion of receiving end 2 of replaceable sleeve 1 is configured to conform to outer ridge 9 when replaceable sleeve 1 covers a substantial amount of writing instrument 6.

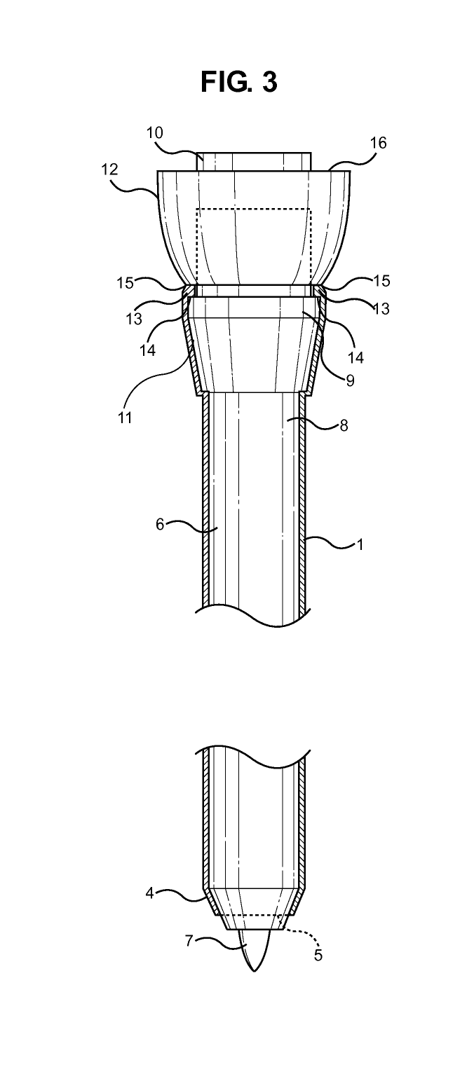

Secondary end 8 of writing instrument 6 is has release mechanism 12 connected thereto. Release mechanism 12 has primary end 15 located opposite secondary end 16. Primary end 15 of release mechanism 12 has opening 17 (FIGS. 1 and 3) configured to receive a portion of writing instrument 6. Secondary end 16 of release mechanism 12 has depressible button 10.

FIG. 3 best depicts replaceable sleeve 1 substantially covering writing instrument 6 and pushing a portion of writing instrument 6 into release mechanism 12, thereby, pushing button 10 to protrude from secondary end 16 of release mechanism 12. Release mechanism 12 has primary end 15 having opening 17 configured to receive an end of writing instrument 6 located opposite secondary end 16. Secondary end 16 of release mechanism 12 has button 10. Button 10 is configured to protrude from a surface of secondary end 16 when a portion of writing instrument 6 is pushed into opening 17 of release mechanism 12 when inner ridge 13 of sleeve 1 interlocks with step 14 of writing instrument 6.

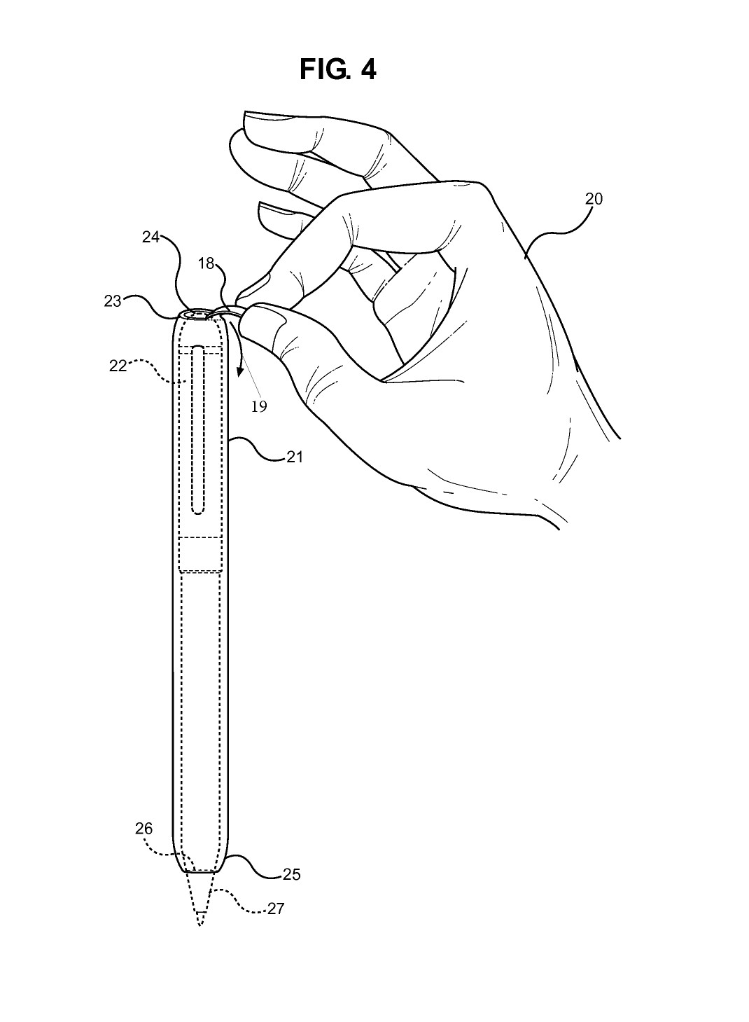

FIG. 4 illustrates an embodiment of removable sleeve 21 having tab 18. Tab 18 is configured to be grasped by user 20 to pull 19 removable sleeve 21 away from writing instrument 22. Removable sleeve 21 has a primary end 23 having primary opening 24 located opposite secondary end 25 having secondary opening 26. It is a preferred embodiment for secondary end 25 to have a tapered configuration. It is within the scope of this invention for removable sleeve 21 to have a constant size in perimeter spanning the length of the removable sleeve 21 and for secondary end 25 to not have a tapered configuration. Primary opening 24 is greater in size than secondary opening 26. Primary opening 24 is configured to receive writing instrument 22. Tip 27 of writing instrument 22 is configured to protrude from secondary opening 26 when writing instrument 22 is substantially covered by replaceable sleeve 21.

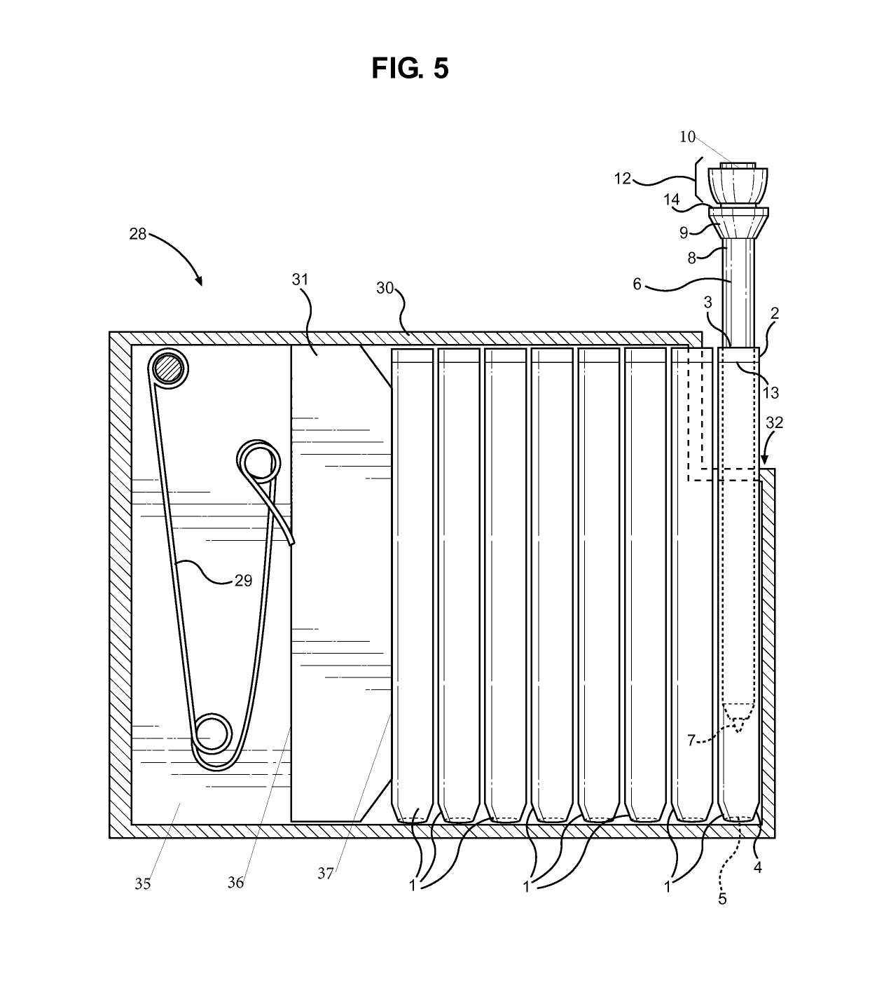

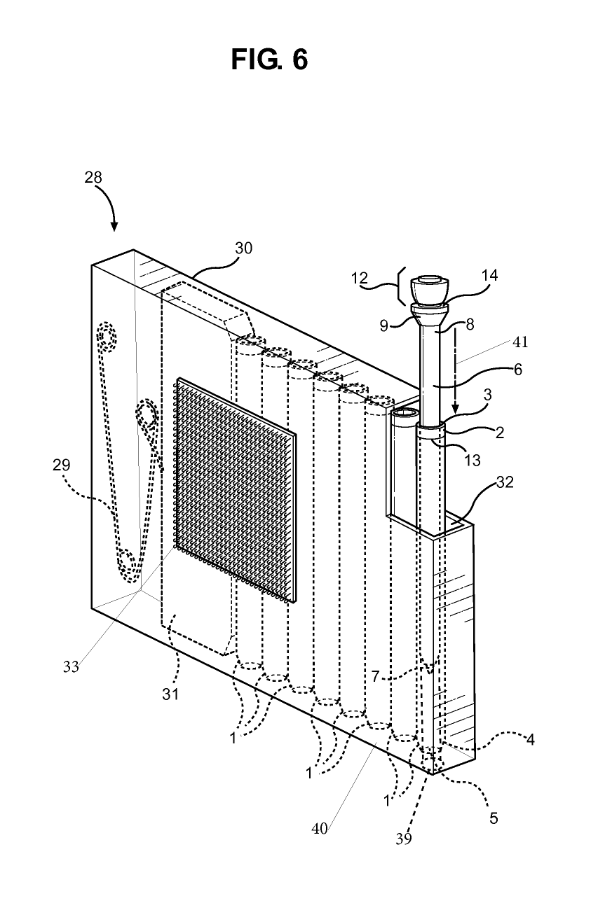

FIGS. 5 and 6 depict dispensing mechanism 28 having receptacle 30 configured to retain a plurality of replaceable sleeves 1. Resilient member 29 includes, but is not limited to, a spring. Resilient member 29 is configured to have an end connected to inner wall 35 of receptacle 30 located opposite another end connected to primary side 36 of plate 31. Plate 31 has primary side 36 connected to resilient member 29 located opposite secondary side 37 connected to at least one replaceable sleeve 1. The tension created from resilient member 29 pushing against plate 31 causes plate 31 to contact and retain at least one replaceable sleeve 1 in an upright orientation at opening 32 of receptacle 30. The replaceable sleeve 1 is pushed towards opening 32 of receptacle 30 by plate 31. Opening 32 allows for a user to access replaceable sleeve 1.

It is within the scope of this invention for receptacle 30 to have primary opening 32 located opposite secondary opening 39 (FIG. 6). Primary opening 32 has a perimeter greater in size than secondary opening 39 perimeter. Secondary opening 32 of receptacle 30 is configured to receive end portion 7 of writing instrument 6 when writing instrument 6 has been inserted through replaceable sleeve 1 retained by receptacle 30. Primary end portion 7 or tip of writing instrument 6 may protrude from lower portion 40 of receptacle 30 when writing instrument 6 has been inserted through both primary opening 32 and secondary opening 39 of receptacle 30 during the installation of replaceable sleeve 1 onto writing instrument 6.

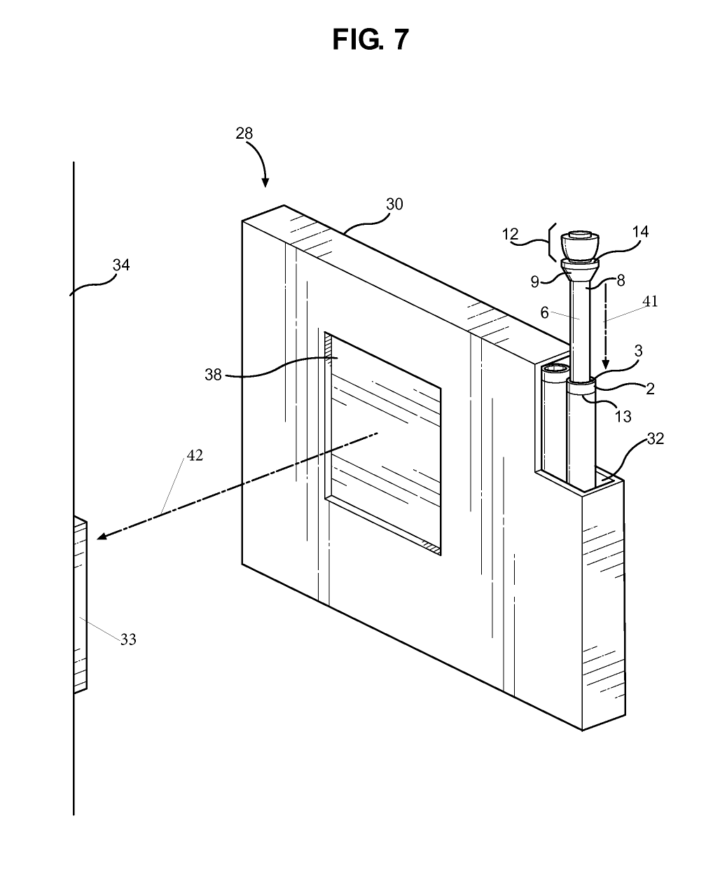

FIG. 6 shows dispensing mechanism 28 having receptacle 30 having at least one attaching element 33 connected to an outer wall surface of receptacle 30. Attaching element 33 is configured to connect to substantially flat surface 34 (FIG. 7). In another embodiment, FIG. 7 depicts substantially flat surface 34 having an attaching element 33 connected thereto. Attaching element 33 is configured to connect with another attaching element connected to receptacle 30 (not shown), thereby retaining receptacle on the flat surface. In another embodiment, receptacle 30 can have at least one recess. Attaching element 33 has a side connected to flat surface 34 located opposite a side configured to connect with an inner recess wall, thereby, mounting receptacle 30 flush onto a wall 34. It is within the scope of this invention for recess 38 or receptacle 30 to be made of a magnetically attractive material. Attaching element 33 has a side configured to connect to wall 34 located opposite another side configured to connect 42 with magnetically attractive recess 38 or magnetically attractive receptacle 30.

These and other important objects, advantages, and features of the invention will become clear as this description proceeds.

The invention accordingly comprises the features of construction, combination of elements, and arrangement of parts that will be exemplified in the description set fourth hereinafter and the scope of the invention will be indicated in the claims.

### Construction of the Novel Writing Instrument Having A Replaceable Sleeve

In a preferred embodiment, writing instrument 6 includes, but is not limited to a stylus, a digital pen, a pen, a marker, a highlighter, or a pencil. Primary opening 3 of replaceable sleeve 1 is configured to receive the primary end 7 of writing instrument 6. A portion of primary end 7 of writing instrument 6 is configured to protrude from secondary opening 5 of replaceable sleeve 1 when replaceable sleeve 1 substantially covers writing instrument 6. Primary end 7 of writing instrument 6 is configured to contact a writing surface when a portion of primary end 7 of writing instrument 6 protrudes from secondary opening 5 of replaceable sleeve 1.

Inner wall surface 11 of receiving end 2 of replaceable sleeve 1 is configured to connect to outer ridge 9 of writing instrument 6. A portion of receiving end 2 is configured to conform to the perimeter of outer ridge 9, thereby, retaining replaceable sleeve 1 onto writing instrument 6. Inner ridge 13 is connected to the perimeter of inner wall surface 11 of replaceable sleeve 1. Outer ridge 9 has an end having seat 14 being configured to interlock with inner ridge 13 of replaceable sleeve 1.

Receiving end 2 of replaceable sleeve 1 is configured to be broken away from outer ridge 9 when button 10 is depressed. Seat 14 of outer ridge 9 is configured to disconnect from inner ridge 13 of replaceable sleeve 1 when button 10 of release mechanism 12 is depressed. Replaceable sleeve 1 is ejected from writing instrument 6. A user is not required to contact replaceable sleeve 1 during the removal process of replaceable sleeve 1 from writing instrument 6.

In a preferred embodiment, replaceable sleeve 1 has receiving end 2 located opposite tapered end 4. It is within the scope of this invention for receiving end 2 of replaceable sleeve 1 to be located opposite an end that is not tapered.

In another embodiment, writing instrument 6 can have release mechanism 12 located on secondary end 8 of writing instrument 9. When inner ridge 13 of replaceable sleeve 1 interlocks with step 14, a portion of writing instrument 6 is pushed into release mechanism 12, thereby extending button 10 to protrude from an end of release mechanism 12. Release mechanism 12 has button 10 configured to be depressed by a user. A user is any person including, but not limited to, an individual, a health care professional, or a patient. Secondary end 8 of replaceable sleeve 1 is configured to disengage from outer ridge 9 when button 10 is depressed, step 14 is disconnected from inner ridge 13. As button 10 is depressed, outer ridge 9 moves forward and replaceable sleeve 1 is disconnected from outer ridge 9 allowing replaceable sleeve to be ejected from writing instrument 6.

It is within the scope of this invention for button 10 to be configured to be depressed by a user, the attached replaceable sleeve 1 is pushed off writing instrument 6 when the writing instrument is pushed forward, which pushes the attached replaceable sleeve 1 beyond outer ridge 9. Replaceable sleeve 1 has a length great enough in size that when substantially covering writing instrument 6, a portion of the writing instrument 6 is pushed into release mechanism 12 resulting in push button 10 to protrude from secondary end 16 of release mechanism 12.

As best shown in FIG. 5, receptacle 30 can retain at least one removable sleeve 1. Removable sleeve 1 can be located next to another removable sleeve 1. Removable sleeve 1 can be oriented in an upright position so a user can easily insert (FIGS. 6 and 7) primary end 7 of writing instrument 6 into primary opening 3 of removable sleeve 1. Once inner ridge 13 of replaceable sleeve 1 and step 14 of writing instrument 6 interlock, a user can then remove writing instrument 6 from receptacle 30. The interlocking of step 14 and inner ridge 13 retain replaceable sleeve 1 on writing instrument 6.

Once removable sleeve 1 has been contaminated and needs to be removed from writing instrument 6; removable sleeve 1 can be sterilized and reused or disposed of. Receptacle 30 can be configured to be mounted to substantially flat surface 34 including, but not limited to, a wall, a desk, a table, a clip board, an electronic memory device, or a tablet. Attaching element 33 including, but not limited to, a magnet, adhesive, tape, double sided tape, a fastener, a hook and loop attachment, or a snap has a side that can be connected to a surface of receptacle 30 located opposite a side that can be connected to substantially flat surface 34. Receptacle 30 can have dispensing mechanism 28 whereby, a plurality of replaceable sleeves 1 are spring released from the dispensing mechanism. It is within the scope of this invention for receptacle 30 to not have a resilient member.

In another embodiment, a removable sleeve can be individually stored in sterilized and sealed packaging.

In another embodiment, replaceable sleeve 21 can have at least one tab 18 (FIG. 4) connected to a surface of replaceable sleeve 21. Tab 18 is configured for user 20 to grip and to pull away 19 the contaminated removable sleeve 21 from writing instrument 22 to uncover writing instrument 22.

In another embodiment, a receptacle has at least one opening configured to receive a portion of the replaceable sleeve covered writing instrument. The perimeter of the opening is made of a pliable material (not shown) including, but not limited to, rubber, plastic, or polyurethane. It is within the scope of this invention for the pliable material to have a durometer of including, but not limited to, between the range of approximately 25A-80 A. The receptacle is configured to receive used or contaminated replaceable sleeves. A writing instrument substantially covered by a replaceable sleeve is inserted through a container opening. The replaceable sleeve connects with a portion of the perimeter opening of the container. The rubber material of the perimeter opening grips a portion of the outer surface of the replaceable sleeve. When the writing instrument is removed from the container, the replaceable sleeve is removed from the writing instrument and contained within a storage compartment of the receptacle. It is within the scope of this invention for a portion of the receptacle such as the storage compartment to be removable from the receptacle for easy disposal or sterilization of the contaminated removable sleeves.

In yet another embodiment, a receptacle can have a plurality of openings (not shown). A primary receptacle opening can receive the writing instrument. A secondary receptacle opening can expel a writing instrument substantially covered with a replaceable sleeve.

Although it is a preferred embodiment for replaceable sleeve 1 to be configured to substantially cover a writing instrument 6 having outer ridge 9 to retain replaceable sleeve 1, it is within the scope of this invention for a replaceable sleeve to be configured to substantially cover any writing instrument. A writing instrument does not need to have a retaining ridge to be substantially covered by the replaceable sleeve. FIG. 4 illustrates writing instrument 22 being substantially covered by replaceable sleeve 21. Secondary end 25 of replaceable sleeve 21 is tapered to retain writing instrument 22 within replaceable sleeve 21. Secondary opening 26 of replaceable sleeve 21 is smaller in size than primary opening 24 of replaceable sleeve 21 to allow tip 27 of writing instrument 22 to protrude from secondary opening 26.

Sleeve 21 is made of a material including, but not limited to, plastic or latex. When a user grasps writing instrument 22 covered by replaceable sleeve 21, the force of a user's grip being applied to the covered writing instrument causes replaceable sleeve 21 to conform to the outer perimeter of writing instrument 22. Thus, the applied force of a user's grip around writing instrument 22 during use will retain replaceable sleeve 21 as it substantially covers writing instrument 22.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

1-14. (canceled)

15. A receptacle having a spring released dispensing mechanism, comprising: at least one opening bordering a compartment, a plate having a first side located opposite a second side, a resilient member, said resilient member having a first end connected to an inner wall of said receptacle and said resilient member having a second end connected to said first side of said plate, said at least one object is located adjacent to said second side of said plate, whereby, a force of said resilient member is configured to push both said plate and said at least sleeve object toward said at least one opening, whereby, said at least one object is configured to be oriented in alignment with said at least one opening for removal from said receptacle.

16. The receptacle having a spring released dispensing mechanism of claim 15, wherein said receptacle having at least one attaching element connected to a surface of said receptacle.

17.20. (canceled)

21. The receptacle having a spring released dispensing mechanism of claim 16, wherein an outer wall surface of said receptacle having a recess, said at least one attaching element is retained by said recess.

22. The receptacle having a spring released dispensing mechanism of claim 21, wherein said recess is made of a magnetically attractive material.

23. The receptacle having a spring released dispensing mechanism of claim 15, wherein a perimeter of said at least one opening bordering said compartment of said receptacle having a recess.

24. The receptacle having a spring released dispensing mechanism of claim 15, wherein said object is a replaceable sleeve, said replaceable sleeve is retained within said receptacle, said replaceable sleeve having a first end having a first opening located opposite a second end having a second opening;
said first opening of said replaceable sleeve having a diameter greater in size than said second opening of said replaceable sleeve;
said first opening of said replaceable sleeve is configured to receive a writing instrument, said writing instrument having an end with a tip located opposite another end, whereby, said replaceable sleeve is configured to cover a substantial portion of said writing instrument when a portion of said tip of said writing instrument protrudes from said second opening of said replaceable sleeve.

25. A receptacle having a spring released dispensing mechanism, comprising:
at least one opening bordering a compartment;
a plate having a first side located opposite a second side;
a resilient member, said resilient member having a first end connected to an inner wall of said receptacle and said resilient member having a second end connected to said first side of said plate, said at least one replaceable sleeve is located adjacent to said second side of said plate, whereby, a force of said resilient member is configured to push both said plate and said at least one replaceable sleeve toward said at least one opening, whereby, said at least one replaceable sleeve is oriented in alignment with said at least one opening for removal from said receptacle;
said at least one replaceable sleeve is retained within said receptacle, said at least one replaceable sleeve having a first end having a first opening located opposite a second end having a second opening;
said first opening of said at least one replaceable sleeve having a diameter greater in size than said second opening of said at least one replaceable sleeve; and,
said first opening of said at least one replaceable sleeve is configured to receive a writing instrument, said writing instrument having an end with a tip located opposite another end, whereby, said at least one replaceable sleeve is configured to cover a substantial portion of said writing instrument when a portion of said tip of said writing instrument protrudes from said second opening of said replaceable sleeve.

26. The receptacle having a spring released dispensing mechanism of claim 25, wherein a perimeter of said at least one opening bordering said compartment of said receptacle having a recess.

27. The receptacle having a spring released dispensing mechanism of claim 25, wherein said receptacle having at least one attaching element connected to a surface of said receptacle.

28. The receptacle having a spring released dispensing mechanism of claim 25, wherein an outer wall surface of said receptacle having a recess, said at least one attaching element is retained by said recess.

29. The receptacle having a spring released dispensing mechanism of claim 28, wherein said recess is made of a magnetically attractive material.
